(19) United States
(12) Patent Application Publication
(10) Pub. No.: US 2009/0109840 A1
(43) Pub. Date: Apr. 30, 2009

(54) Fault-resistant digital-content-stream AV packet switch

(76) Inventors: Brian L. Hallse, Orange, CA (US); Melvin G. Gable, Cowan Heights, CA (US)

Correspondence Address: HENNEMAN & ASSOCIATES, PLC, 714 W. MICHIGAN AVE., THREE RIVERS, MI, 49093, US

(21) Appl. No.: 11/981,525

(22) Filed: Oct. 31, 2007

(51) Int. Cl. G01R 31/08

(52) U.S. Cl. 370/218

(57) ABSTRACT

An AV packet switch comprises a multiplexer system having multiple multiplexer input terminals and multiple multiplexer output terminals, a particular multiplexer input terminal capable to receive an input stream synchronized with a first clock signal, a particular multiplexer output terminal capable to receive the input stream from the particular multiplexer input terminal; and an output stream destination synchronizer coupled to the particular switch output terminal capable to synchronize the input stream with a destination's clock signal.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to routing of digital content streams, and more particularly provides a fault-resistant digital content stream multimedia switch.

### BACKGROUND

Conventionally, cable and satellite content providers provide multimedia content in the form of analog signals using various delivery methods. These delivery methods typically require the cable or satellite provider to provide a set top box capable of enabling a user to select specified content to be delivered to the set top box, and capable of displaying the selected content on the television set coupled to the set top box. Typically, the user can also record the selected content using a recording device, such as a video-cassette recorder (“VCR”), a digital video recorder (“DVR”), a digital versatile disk (“DVD”) recorder, or a high-definition digital video device (“HDDVD”) recorder.

Cable and satellite providers are moving to the delivery of multimedia content in digital formats. For example, multimedia content can be conveyed using a digital transport stream that conforms to industry standards, such as the Motion Picture Expert Group-2 (“MPEG-2™”) standard of the Motion Picture Experts Group, the DIRECTV™ standard of DIRECTV, Inc., the Digital Video Broadcasting (“DVB”) open standard, the Digital Video (“DV™”) standard of Sony Corporation, and/or the High-Definition Digital Video (“HDV™”) standard of Sony Corporation. Using a set top box, a user selects desired multimedia content. The selected multimedia content is conveyed in a digital transport stream to the set top box, which presents the multimedia content on a display device. Further, the multimedia content can be recorded by a digital recording device, e.g., a hard drive, and/or can be forwarded to other devices, e.g., a second set top box or personal computer.

The current embodiments of digital-content-stream AV packet switches have no mechanism for preventing the truncation of packets when the AV packet switch source is connected or disconnected. This results in the loss of multimedia content at the destination. When the AV packet switch destination is an output device such as a video display and audio speakers, there may be loss of quality noticeable to the user. If the destination is a recording device, there will be permanent and irrecoverable loss of multimedia content. For example, when the multimedia destination is a hard disk, and the AV packet switch is changed by the user to select a new combination of multimedia source and multimedia destinations, there would be a loss of one or more multimedia content packets during the time the source and destinations are switched. Accordingly, there is a need for improved switches that enable switching of the multimedia source and/or multimedia destination without loss of multimedia content at the multimedia destination.

### SUMMARY

In accordance with an embodiment, the present invention provides an AV packet switch comprising a multiplexer system having multiple multiplexer input terminals and multiple multiplexer output terminals, a particular multiplexer input terminal capable to receive an input stream synchronized with a first clock signal, a particular multiplexer output terminal capable to receive the input stream from the particular multiplexer input terminal; and an output stream destination synchronizer coupled to the particular switch output terminal capable to synchronize the input stream with a destination's clock signal.

The AV packet switch may further comprise an input stream source synchronizer having a source synchronizer data input terminal capable to receive the input stream synchronized with a source's clock signal and a source synchronizer clock input terminal capable to receive the source's clock signal, and wherein the input stream source synchronizer is capable to synchronize the input stream received at the source synchronizer data input terminal with the first clock signal. The multiplexer system may be software controlled. The multiplexer system may include a null source input terminal capable of generating a null source signal, and wherein the multiplexer system couples the null source input terminal to the particular multiplexer output terminal when the particular multiplexer output terminal is not configured to receive any data stream from any multiplexer input terminal. The destination synchronizer may include a state machine configured to wait for an end-of-packet before changing from a particular active state. The state machine may be configured to go through a null state before changing from a first active state to a second active state. The multiplexer system may couple the null source input terminal to the particular multiplexer output terminal during the null state. The multiplexer system may couple the particular multiplexer input terminal to the particular multiplexer output terminal during the first active state. The multiplexer system may couple the particular multiplexer input terminal to a second particular multiplexer output terminal when changing to the second active state. The multiplexer system may maintain the particular input terminal coupled to the particular multiplexer output terminal when changing to the second active state. The input stream source synchronizer may obtain a backup clock signal for use when the source's clock signal is unavailable. The output stream destination synchronizer may obtain a backup clock signal for use when the destination's clock signal is unavailable.

In accordance with another embodiment, the present invention provides a system comprising an AV packet switch having multiple switch input terminals and multiple switch output terminals, and being configurable to route data from one or more switch input terminals to one or more switch output terminals according to a configuration scheme; a first particular switch input terminal being capable of receiving a data input stream; a time stamper coupled to a first particular switch output terminal and being capable of time stamping individual packets of the data input stream; a timing reconstruction block coupled to a second particular switch input terminal and being capable of receiving the individual packets time-stamped by the time stamper; an encryption/decryption engine coupled to a second particular switch output terminal and being capable of encrypting or decrypting the data input stream; an encryption/decryption block coupled to a third particular switch input terminal and being capable of receiving the data stream encrypted or decrypted by the encryption/decryption engine; and a third particular switch output terminal for transmitting the data stream from the AV packet switch.

The first particular switch input terminal may be coupled to a receive engine capable of receiving the data input stream according to a format specified by IEEE 1394. The third particular switch output terminal may be coupled to a transmit engine capable of transmitting the data input stream according to a format specified by IEEE 1394. The third particular switch output terminal may be coupled to an AV decoder capable of transmitting the data input stream according to a format different than one specified by IEEE 1394. The data input stream received at the first particular switch input stream may be in a serial format or in a parallel format. The system may further comprise a PID filter coupled to a fourth particular switch output terminal and being capable to extract a data program from an MPEG data stream; and a PID filter block coupled to a fourth particular switch input terminal and being capable of receiving the extracted data program from the PID filter.

In accordance with yet another embodiment, the present invention provides a method in an AV packet switch comprising receiving an input stream synchronized with a source's clock signal at a particular one of several switch input terminals; synchronizing the input stream with a common clock signal; routing the input stream to a particular one of several switch output terminals; and synchronizing the input stream with a destination's clock signal.

### BRIEF DESCRIPTION OF THE DRAWINGS

FIG. 1 is a block diagram illustrating a fault-resistant digital-content-stream AV packet switch, in accordance with an embodiment of the present invention.

FIG. 2 is a block diagram illustrating details of the fault-tolerant digital-content-stream AV packet switch, in accordance with an embodiment of the present invention.

FIG. 3 is a block diagram illustrating an input stream source synchronizer, in accordance with an embodiment of the present invention.

FIG. 4 is a block diagram illustrating an output stream destination synchronizer, in accordance with an embodiment of the present invention.

FIG. 5 is a state machine diagram, in accordance with an embodiment of the present invention.

FIG. 6 is a timing diagram for the input stream source synchronizer, in accordance with an embodiment of the present invention.

FIG. 7 is a block diagram illustrating a system including a fault-resistant digital-content-stream AV packet switch connected to typical external hardware blocks, in accordance with an embodiment of the present invention.

FIG. 8A is a block diagram illustrating a system configured to record an AV stream received using an IEEE 1394 interface, in accordance with an embodiment of the present invention.

FIG. 8B is a block diagram illustrating a system configured to encrypt and transmit a received digital content stream to an AV decoder, in accordance with an embodiment of the present invention.

FIG. 8C is a block diagram illustrating a system configured to route a received digital content stream to the AV decoder, in accordance with an embodiment of the present invention.

FIG. 8D is a block diagram illustrating a system configured to encrypt and store a received digital content stream in external storage, in accordance with an embodiment of the present invention.

FIG. 8E is a block diagram illustrating a system configured to receive an encrypted digital content stream, to decrypt the digital content stream, and to transmit the decrypted digital content stream to an AV decoder, in accordance with an embodiment of the present invention.

FIG. 8F is a block diagram illustrating a system configured to route a received digital content stream to more than one output, in accordance with an embodiment of the present invention.

FIG. 8G is a block diagram illustrating a system configured to route a digital content stream received in bit-serial format to both bit serial and parallel outputs, in accordance with an embodiment of the present invention.

### DETAILED DESCRIPTION

The following description is provided to enable any person skilled in the art to make and use the invention and is provided in the context of a particular application. Various modifications to the embodiments are possible, and the generic principles defined herein may be applied to these and other embodiments and applications without departing from the spirit and scope of the invention. Thus, the invention is not intended to be limited to the embodiments and applications shown, but is to be accorded the widest scope consistent with the principles, features and teachings disclosed herein.

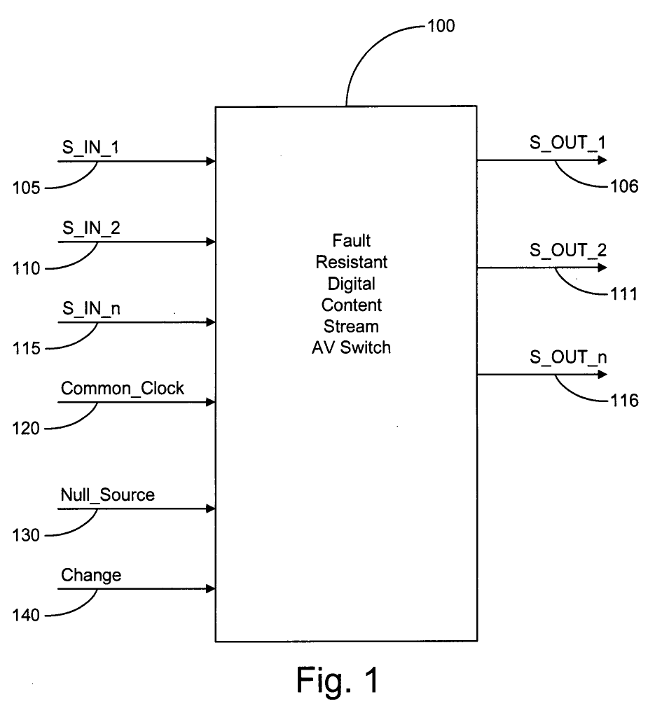

FIG. 1 is a block diagram illustrating a fault-resistant digital-content-stream AV packet switch 100, in accordance with an embodiment of the present invention. AV packet switch 100 is capable of performing source and destination selection changes without loss of multimedia content during the switch.

In the embodiment shown, AV packet switch 100 includes S_IN_1 input terminal 105 for receiving digital content input stream S_IN_1, S_IN_2 input terminal 110 for receiving digital content input stream S_IN_2, and S_IN_n input terminal 115 for receiving digital content input stream S_IN_n. The digital content input streams S_IN_1, S_IN_2, S_IN_n can have any specified stream format including those compliant with the Motion Picture Expert Group (MPEG) program standard, IEEE 1394 standard, Digital Video (“DV™”) standard, Digital Satellite Service (“DSS”) standard, or the like. Each of the digital content streams S_IN_1, S_IN_2, S_IN_n can be serial (e.g., bit serial) or parallel (e.g., byte parallel). The AV packet switch 100 includes S_OUT_1 output terminal 106 for transmitting digital content output stream S_OUT_1, S_OUT_2 output terminal 111 for transmitting digital content output stream S_OUT_2, S_OUT_n output terminal 116 for transmitting digital content output stream S_OUT_n, each being based on or including one or more of the received input streams S_IN_1, S_IN_2, S_IN_n.

In one embodiment, the AV packet switch 100 can be configured using a software control program to route a digital content input stream S_IN_1, S_IN_2, S_IN_n received on one of the input terminals 105/110/115 to one or more of the output terminals 106/111/116. In addition, in one embodiment, digital content input streams S_IN_1, S_IN_2, S_IN_n received on multiple input terminals 105/110/115 can be routed to multiple output terminals 106/111/116 at the same time.

The AV packet switch 100 uses a common clock 120, which can be externally supplied or internally generated. The input streams S_IN_1, S_IN_2, S_IN_n and output streams S_OUT_1, S_OUT_2, S_OUT_n may be synchronous with the common clock 120. Embodiments can include one or more clock generators to generate one or more clock signals to be used by external hardware connected to the input terminals 105/110/115 and output terminals 106/111/116.

The AV packet switch 100 further includes a null source input terminal 130 and a change input terminal 140. Each output terminal 106/111/116 may be initially connected to the null source input terminal 130, which holds the output terminals 106/111/116 in a static condition. In one embodiment, the null source input terminal 130 may be contained within the AV packet switch 100 and may not receive an external input signal. When the AV packet switch 100 is instructed to connect one or more of the input terminals 105/110/115 to one or more of the output terminals 106/111/116, then a change_input_signal on the change input terminal 140 may be asserted. Asserting the change_input_signal disassociates the selected output terminals 106/111/116 from the null source input terminal 130 and associates the input terminals 105/110/115 to the output terminals 106/111/116 as instructed.

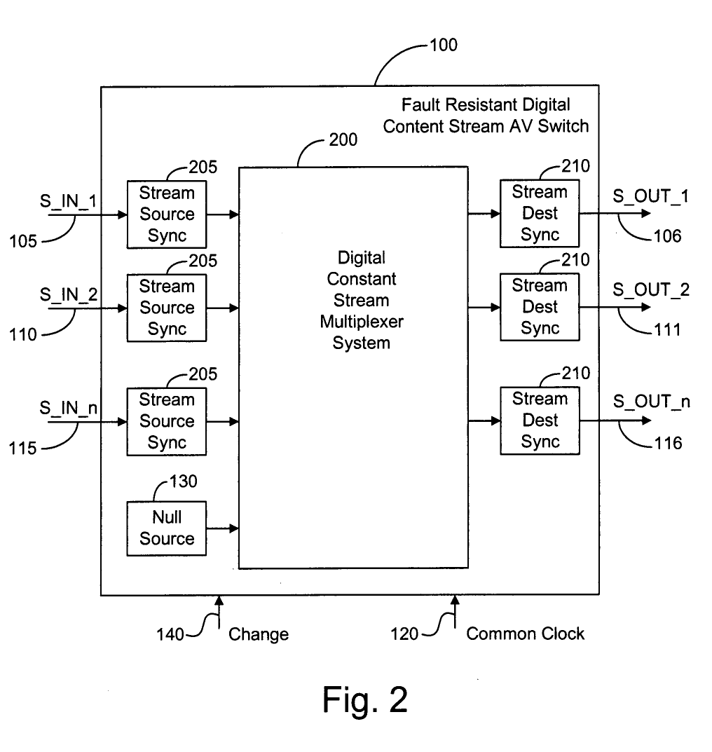

FIG. 2 is a block diagram illustrating details of the fault-tolerant digital-content-stream AV packet switch 100, in accordance with an embodiment of the present invention. AV packet switch 100 includes digital content stream multiplexer system 200, input stream source synchronizers 205, and output stream destination (“Dest”) synchronizers 210. The AV packet switch 100 receives input streams S_IN_1, S_IN_2, S_IN_n that may be synchronous with the common clock 120 or another clock, and provides output streams S_OUT_1, S_OUT_2, S_OUT_n that may be synchronous with the common clock 120 or another clock.

In one embodiment, the input stream source synchronizer 205 synchronizes the input stream S_IN_1, S_IN_2, S_IN_n that are synchronous with an external clock to the common clock 120. The output stream destination synchronizer 210 synchronizes the received input streams that are synchronous with the common clock 120 to an external clock used by external hardware to generate output streams S_OUT_1, S_OUT_2, S_OUT_n.

The multiplexer system 200 includes circuitry for routing the received data streams from appropriate input terminals 105/110/115 to the appropriate output terminals 106/111/116. The multiplexer system 200 may also include circuitry for translating between digital transport stream standards, e.g., from IEEE 1394 to MPEG-2. In another embodiment, digital transport stream translation circuitry may be external to the AV packet switch 100.

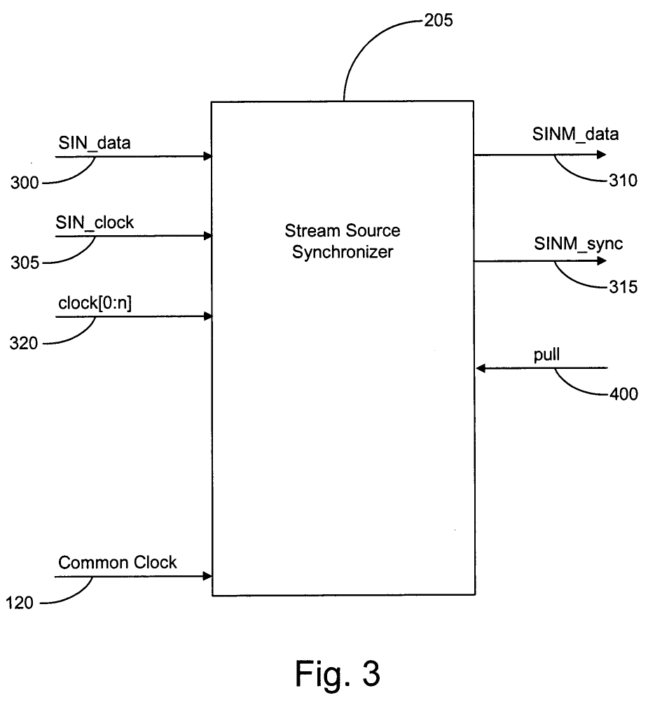

FIG. 3 is a block diagram illustrating an input stream source synchronizer 205, in accordance with an embodiment of the present invention. In one embodiment, stream source synchronizer 205 has SIN_data and SIN_clock input terminals 300 and 305 for receiving SIN_data and SIN_clock signals from external hardware. The SIN_data input terminal 300 is used to receive digital content input stream SIN_data, and the SIN_clock input terminal 305 is used to receive the clock signal SIN_clock that corresponds to the digital content stream SIN_data. The clock signal SIN_clock is used to gate data received on SIN_data input terminal 300. The input stream SIN_data can be a bit serial input stream or a parallel input stream, e.g., a byte parallel stream.

Input stream source synchronizer 205 receives the common clock 120, and optionally receives one or more clock signals clock [0:n] 320 generated by the AV packet switch 100. Input stream source synchronizer 205 synchronizes the received input stream SIN_data with respect to the common clock 120, and transmits the synchronized digital content stream on the SINM_data output terminal 310 to the AV packet switch 100. In addition, input stream source synchronizer 205 transmits a synchronization (SINM_sync) signal 315 that can be used by the AV packet switch 100 to gate SIN_data input stream received on SINM_data input terminal 310. The generated clocks [0:n] 320 optionally can be used to gate the SIN_data input stream received on SIN_data input terminal 300, for example, when the external hardware does not supply a clock signal on SIN_clock 305. Further, a pull signal 400 may be received from the output stream destination synchronizer 210 to time the transmission of the SINM_data input stream to the output stream destination synchronizer 210.

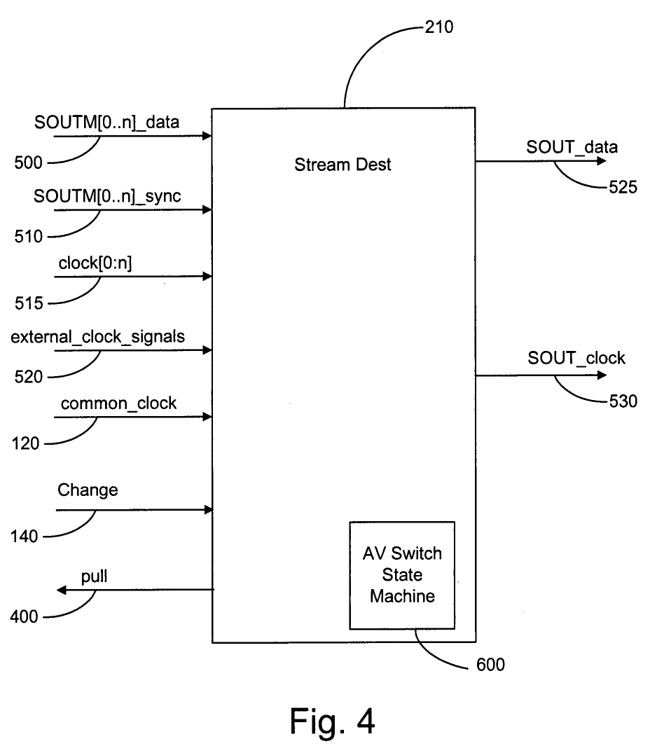

FIG. 4 is a block diagram illustrating an output stream destination synchronizer 210, in accordance with an embodiment of the present invention. The output stream destination synchronizer 210 receives input stream SOUTM_data and SOUTM_sync (which may be synchronous with SINM_sync and/or the common clock), and synchronizes them from the common clock 120 to a clock used by external hardware to generate output streams S_OUT_1, S_OUT_2, S_OUT_n. The output stream destination synchronizer 210 has an SOUT_data output terminal 525 used to transmit the digital content stream SOUT_data synchronous with a clock signal SOUT_clock supplied on the SOUT_clock terminal 530 to the external hardware.

The output stream destination synchronizer 210 receives a number of clock signals including the common clock 120, external clock signals 520, and one or more clock signals clock [0:n] 515 generated by the AV packet switch 100. The clock signal SOUT_clock can be any of the clock signals received by output stream destination synchronizer 210. The output stream SOUT_data transmitted on SOUT_data output terminal 525 can be a serial stream, e.g., bit-serial, or a parallel stream, e.g., byte-parallel.

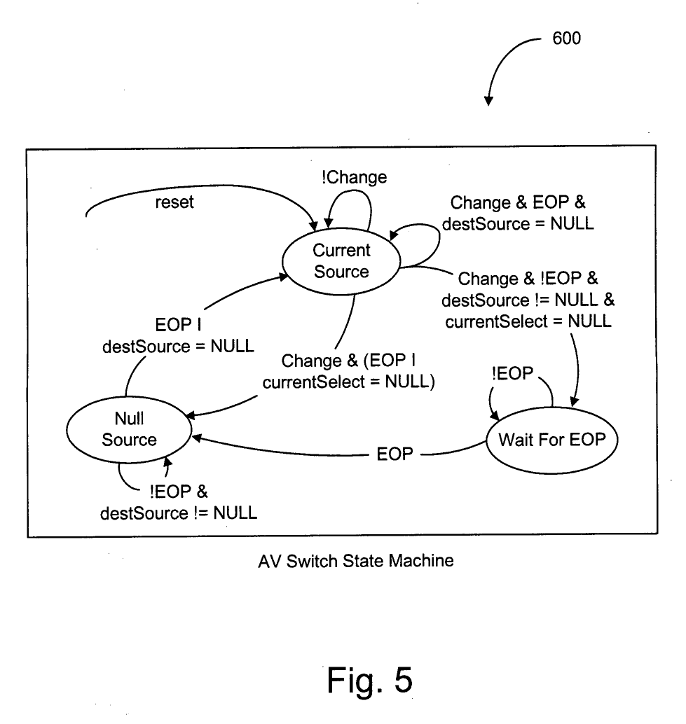

FIG. 5 is a diagram illustrating an AV packet switch state machine 600, in accordance with an embodiment of the present invention. The AV packet switch state machine 600 controls when data is passed through the multiplexer 200.

When the device starts up, the state machine 600 initializes to the CurrentSource state. At startup, the CurrentSelect source will always be a Null source. When there is a commanded change in source, and the End of packet (EOP) is not seen in the current AV Data Stream, and the destination source is not the NULL source, then the state machine 600 transitions to the WaitForEOP state. A commanded change occurs, when the destination source is not the same as the current source. The EOP indication is detected for MPEG and DSS data when the Start Of packet (SOP) for the next packet is indicated. For DV Data streams, the EOP is detected when the Valid signal goes low. If while in the CurrentSource state, there is a commanded change, and there is either an EOP in the current AV Data Stream, or the current Source is the Null source, then the state machine 600 transitions to the Null Source state. While in the WaitForEOP state, if an EOP is seen in the current AV Data Stream, then the state machine 600 transitions to the Null Source state. While in the Null Source state, the State Machine 600 waits for an EOP in the AV Data Stream, from new destination source at which point, the State Machine 600 transitions to the currentSource state. The State Machine 600 also transitions to the currentSource state form the NullSource state, if the destination source is the NULL source.

When programming a source connection for a destination device, if interrupts are enabled for the destination device, and they do not occur within some determined time, then there has been some sort of transition issue. To determine where the state machine 600 is at, the current destination state can be read from the destination setup register.

If the State Machine 600 is residing in the WaitForEOP state, then the current source device has most likely already stopped, and the AV Data Stream is not being generated. This will happen if the current source device is stopped before the destination has been programmed to switch to a new source. The programming of the destination may occur before the current source device is stopped. To get out of this state, the destination may be forced into the Null Source state, by setting the DesState bits of the destination setup register to the NullSource state, and then toggling the Update State bit of the setup register.

If the State Machine 600 is residing in the Null Source state after a programmed change timeout interval, then the new source device has either not been configured, or the wrong source has been selected. To correct this, either the new source is started or the correct source device is reprogrammed into the destination setup register.

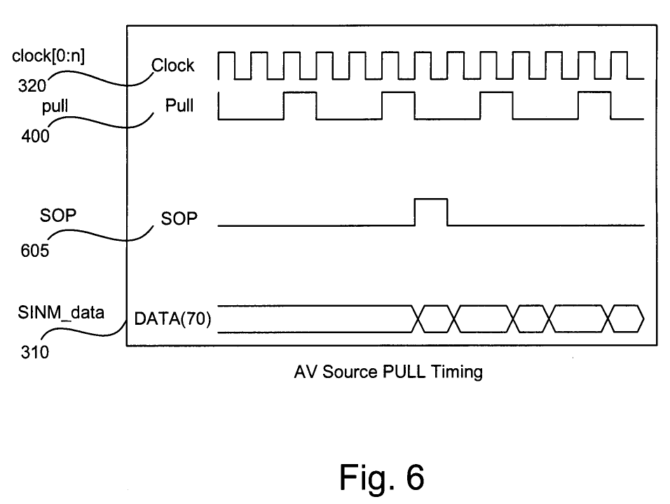

FIG. 6 is a timing diagram for the input stream source synchronizer 205, in accordance with an embodiment of the present invention. The timing diagram illustrates the timing of the SINM_data 310, clock[0:n] 320, the periodic pull signal 400, and the start-of-packet (SOP) signal 605. The SOP signal 605 is embedded within the data stream SINM_data on the SINM_data input terminal 310. When the state machine 600 receives an SOP signal embedded in the data stream SINM_data, then the output stream destination synchronizer 210 begins transferring data from SOUTM_data terminal 500 to the SOUT_data terminal 525. The output stream destination synchronizer 210 pulls the data from the input stream source synchronizer 205 at the rate defined by the period of the pull signal 400.

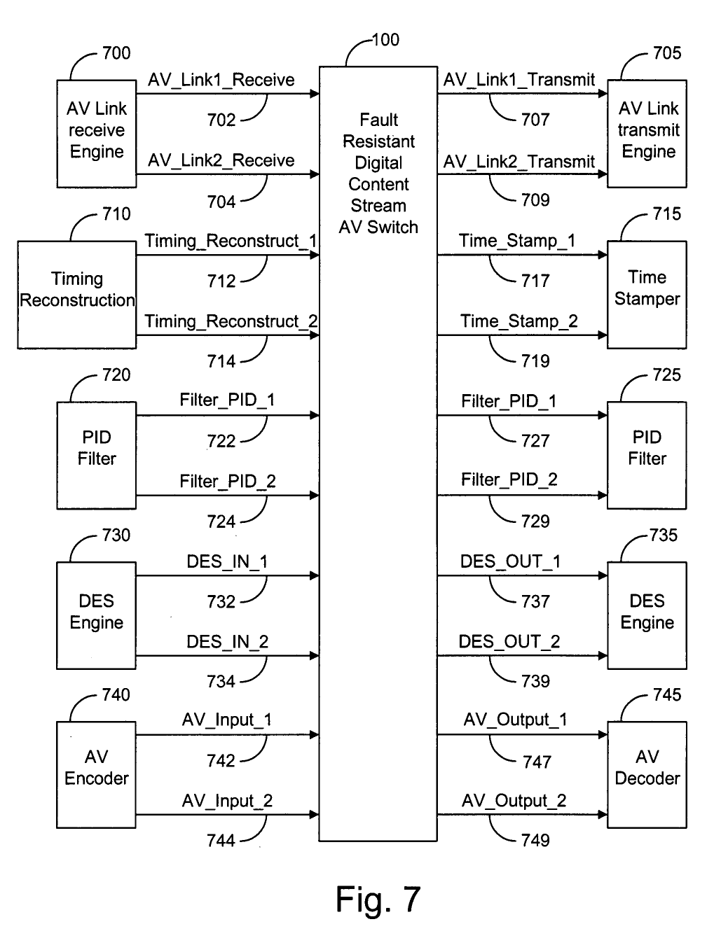

FIG. 7 is a block diagram illustrating a system including an AV packet switch 100 connected to typical external hardware blocks, in accordance with an embodiment of the present invention.

The AV packet switch 100 has an AV_Link1_Receive input terminal 702, and an AV_Link2_Receive input terminal 704 that receive digital content streams from an AV link receive engine 700. The AV link receive engine 700 receives digital content streams in a format specified by the IEEE 1394 standard, and converts them to a format specified by the AV packet switch 100.

The AV packet switch 100 includes a Timing_Reconstruct_1 input terminal 712 and a Timing_Reconstruct_2 input terminal 714 that are used to receive streams from a timing reconstruction block 710. The timing reconstruction block 710 reconstructs the timing of individual packets that are part of a digital content stream using time stamps contained in the individual packets, and transmits the individual packets in accordance with the reconstructed timing to the AV packet switch 100.

The AV packet switch 100 includes two a Filter_PID_1 input terminal 722, and Filter_PID_2 input terminal 724 that are used to receive digital content streams from a Program Stream Identifier (“PID”) filter 720. The PID filter 720 receives an MPEG transport stream, and extracts one or more MPEG program streams to be transmitted to the AV packet switch 100.

The AV packet switch 100 also includes a DES_IN_1 input terminal 732 and a DES_IN_2 input terminal 734 that are used to receive cooperatively manage encryption and/or decryption of digital content streams from a Data Encryption Standard (“DES”) engine 730.

The AV packet switch 100 includes an AV_Input_1 input terminal 742 and an AV_Input_2 input terminal 744 that receive an AV content stream, e.g., an AV content stream in the MPEG elementary stream format, from an AV encoder 740. The AV encoder 740 can source an MPEG, DV™, HDV™, DSS or other AV content data stream.

The AV packet switch 100 includes a number of output terminals that are used to transmit digital content streams to external hardware. Such external hardware can include an AV link transmit engine 705, a time stamper 715, a PID filter 725, a DES engine 735, and an AV decoder 745.

The AV link transmit engine 705 receives a digital content stream from the AV packet switch 100 and formats it in accordance with the IEEE 1394 standard. The time stamper 715 is used to receive an isochronous digital content stream from the AV packet switch 100, and to insert time stamps in the individual packets of the isochronous stream. The timing reconstruction block 710 can use the time stamps inserted by the time stamper 715 to reconstruct the timing of the packets of the isochronous stream. The PID filter 725 receives a digital content stream, e.g., an MPEG transport stream, and extracts one or more MPEG program streams from the transport stream. The DES engine 735 encrypts and/or decrypts a digital content stream from the AV packet switch 100. The AV decoder 745 is used to receive and present an AV content stream, e.g., a MPEG elementary stream.

The AV packet switch 100 includes two an AV_link1_Transmit output terminal 707 and AV_link2_Transmit output terminal 709 that are used to transmit digital content streams to the AV link transmit engine 705. The AV packet switch 100 includes a Time_Stamp_1 output terminal 717 and a Time Stamp_2 output terminal 719 that are used to transmit digital content streams to the time stamper 715. The AV packet switch 100 includes a Filter_PID_1 output terminal 727 and a Filter_PID_2 output terminal 729 that are used to transmit digital content streams to the PID filter 725. The AV packet switch 100 has a DES_OUT_1 output terminal 737 and a DES_OUT_2 output terminal 739 that are used to transmit digital content streams to the DES engine 735 for encryption and/or decryption. The AV packet switch 100 includes an AV_Output_1 output terminal 747 and an AV Output_2 output terminal 749 that are used to output digital content streams to the AV decoder 745.

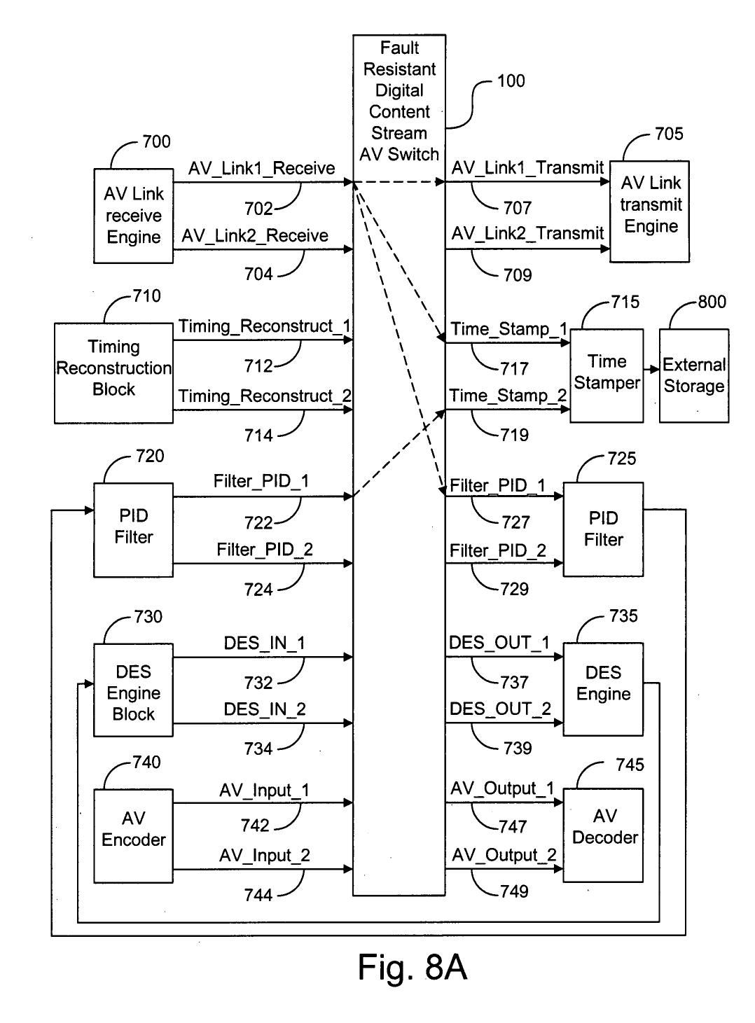

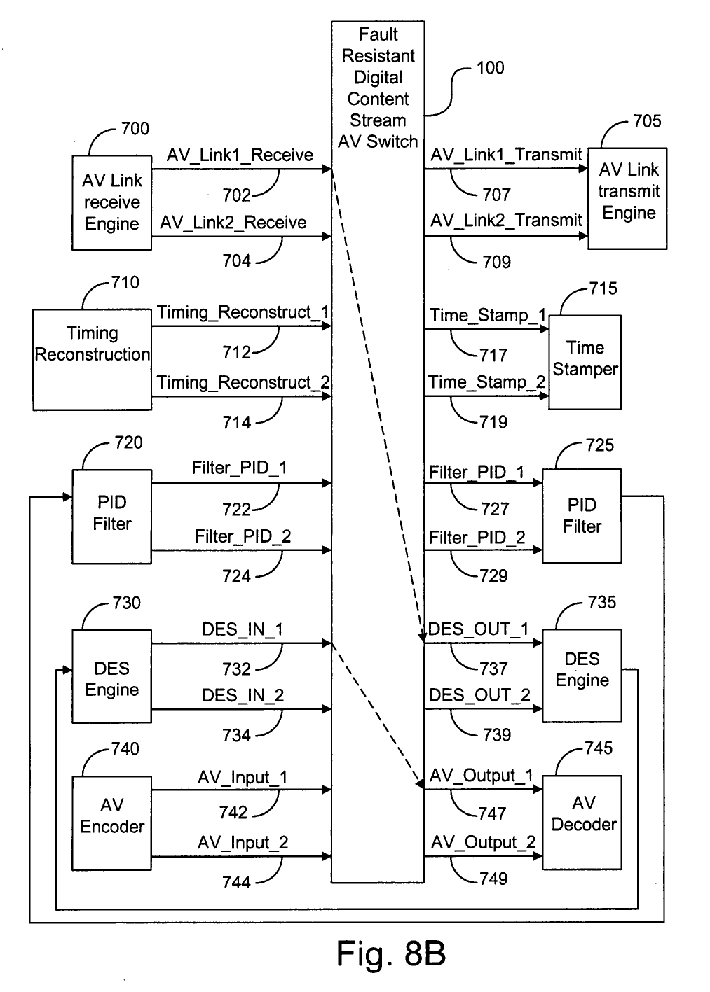

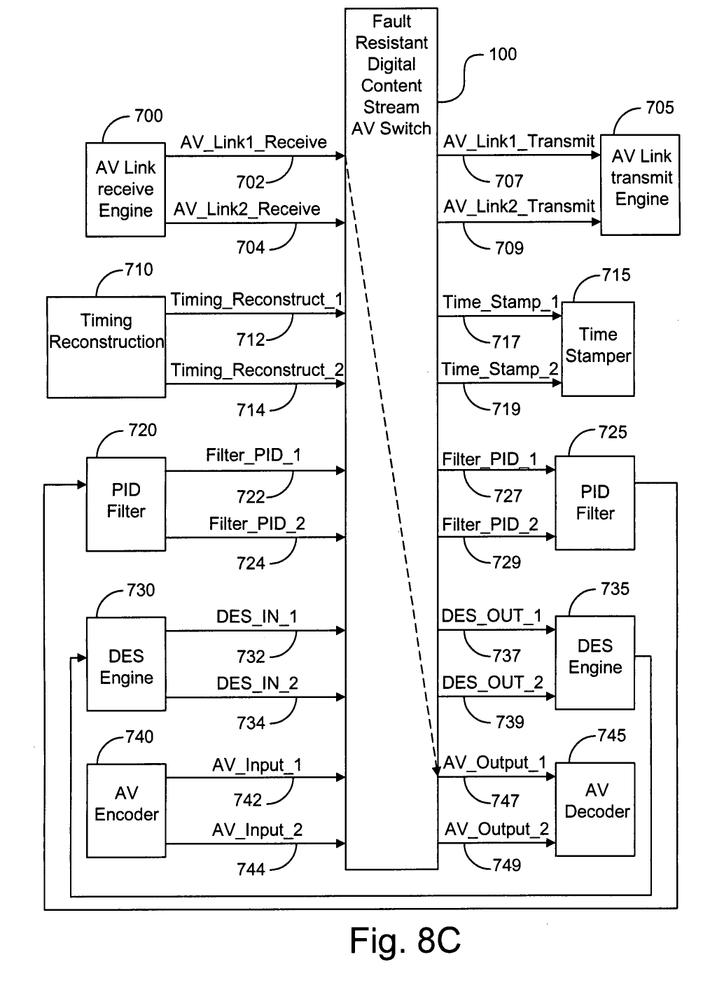

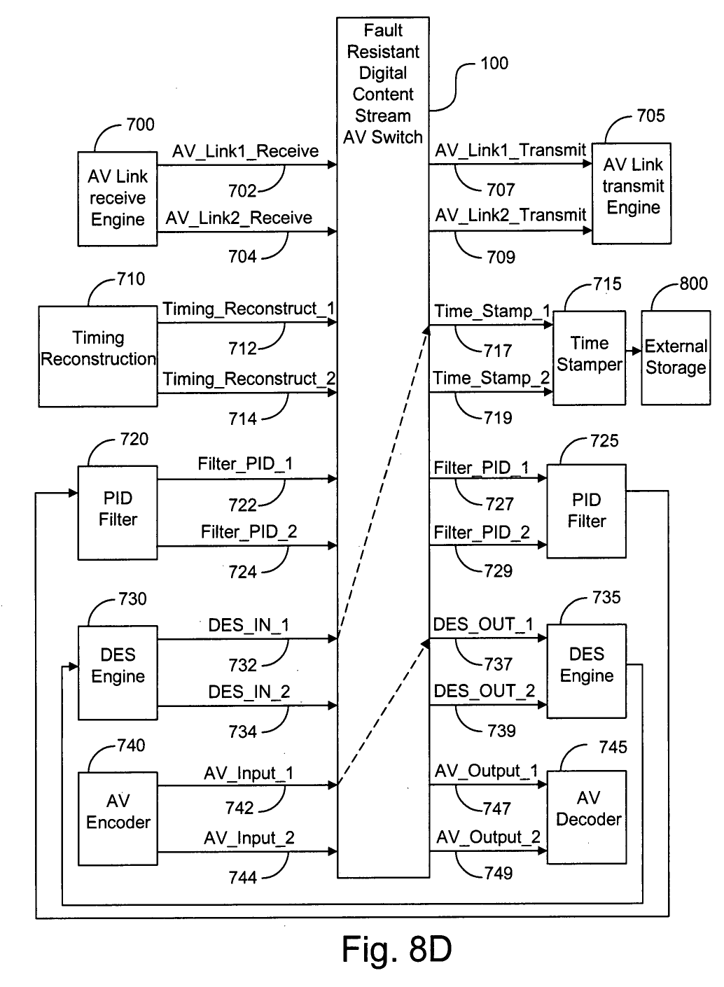

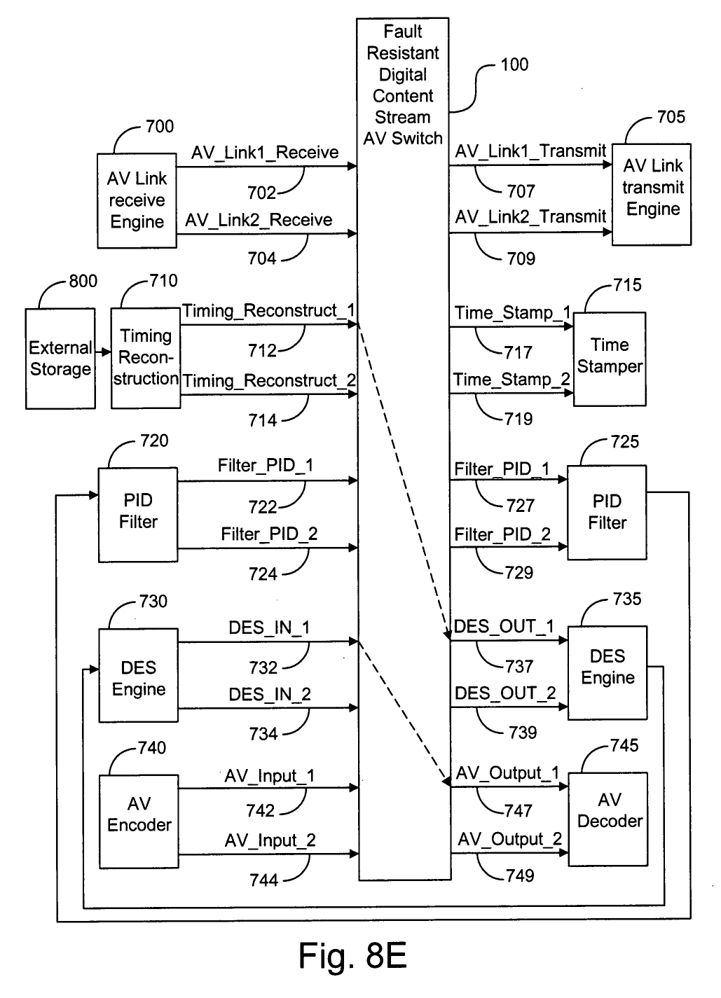

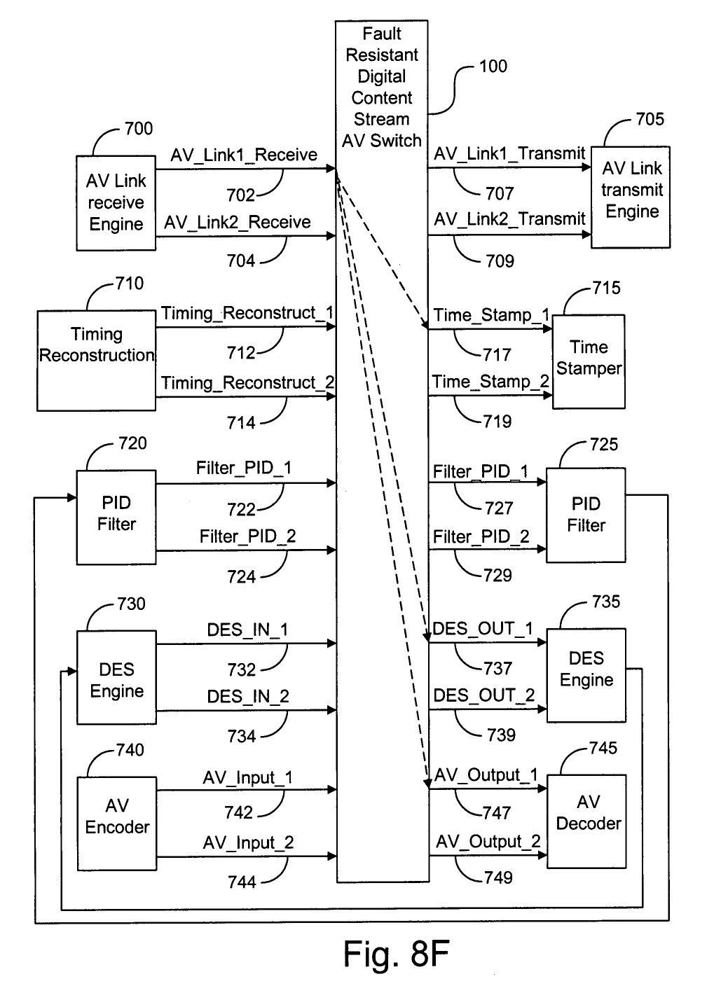

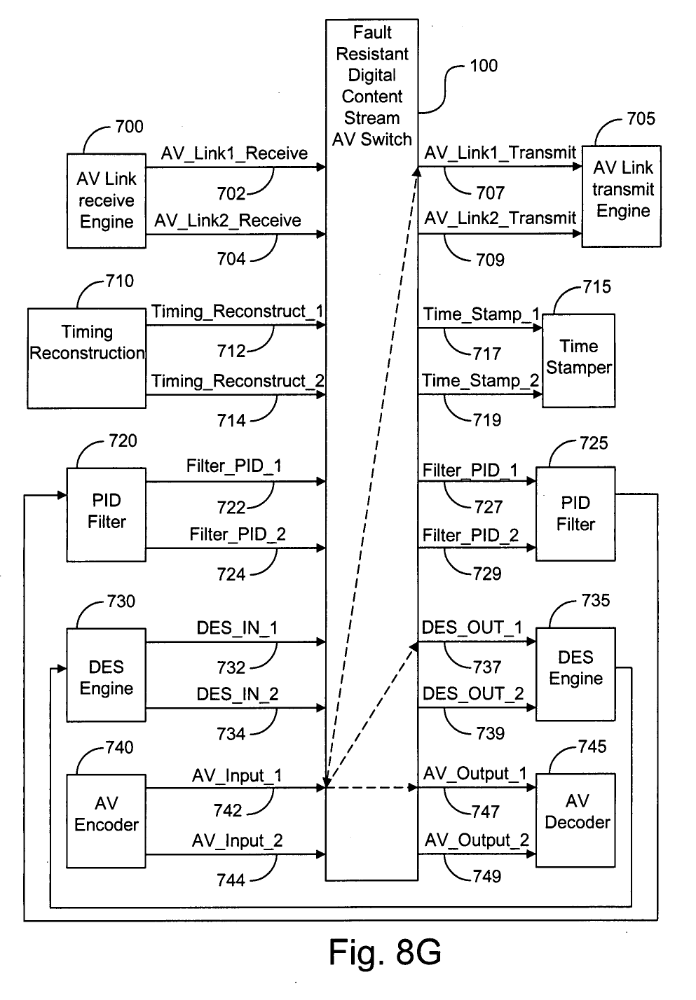

FIG. 8A is a block diagram illustrating a system configured to record an AV stream received using an IEEE 1394 interface, in accordance with an embodiment of the present invention. The digital content stream is received by the AV link receive engine 700 and is transmitted to the AV packet switch 100 on AV_Link1_Receive input terminal 702. In this example, the AV packet switch 100 is configured to route digital content streams received on AV_Link1_Receive input terminal 702 to the AV_Link1_Transmit output terminal 707, to the Time_Stamp_1 output terminal 717, and to the Filter_PID_1 output terminal 727.

Digital content streams transmitted on AV_Link1_Transmit 707 are transmitted to the AV link transmit engine 705 for further transmission to other devices.

Digital content streams transmitted on output Time Stamp_1 output terminal 717 are transmitted to the time stamper 715, which time stamps the individual packets of the digital content stream. The time stamped packets are transmitted to external storage 800, e.g., a hard disk drive.

The digital content stream routed to the Filter_PID_1 output terminal 727 are transmitted to the PID filter 725. The PID filter 725 extracts one or more MPEG program streams from the digital content stream and transmits the extracted MPEG program streams to other devices. As shown, the extracted MPEG program streams can be transmitted as a second digital content stream to the PID filter 720. The PID filter 720 extracts one or more MPEG program streams from the second digital content stream, in accordance with the configuration of the PID filter 720, and transmits the extracted MPEG program streams to the AV packet switch 100 on input Filter_PID_1 input terminal 722. The AV packet switch 100 routes digital content streams received on input Filter_PID_1 input terminal 722 to the Time_Stamp_2 output terminal 719. Digital content streams transmitted using Time_Stamp_2 output terminal 719 are transmitted to the time stamper 715, which time stamps the individual packets of the digital content stream. The time-stamped packets are transmitted to external storage 800.

FIG. 8B is a block diagram illustrating a system configured to encrypt and transmit a received digital content stream to an AV decoder, in accordance with an embodiment of the present invention. The digital content stream is received by the AV link receive engine 700 using an IEEE 1394 interface and is transmitted to the AV packet switch 100 using AV_Link1_Receive input terminal 702. The AV packet switch 100 is configured to route packets received on AV_Link1_Receive input terminal 702 to the DES_OUT_1 output terminal 737 for encryption. The DES_OUT_1 output terminal 737 is connected to the DES engine 735. The DES engine 735 encrypts the digital content stream and transmits the encrypted digital contact stream to the AV packet switch 100 using DES_IN 1 input terminal 732. The AV packet switch 100 is configured to route packets received on DES_IN_1 input terminal 732 to AV_Output_1 output terminal 747. The digital content stream received on AV_Output_1 output terminal 747 is routed to the AV decoder 745.

FIG. 8C is a block diagram illustrating a system configured to route a received digital content stream to the AV decoder, in accordance with an embodiment of the present invention. The digital content stream is transmitted from AV link receive engine 700 to the AV packet switch 100 on AV_Link1_Receive input terminal 702 in a format specified by an IEEE 1394 standard. The AV packet switch 100 is configured to route digital content streams received on AV_Link1_Receive input terminal 702 to the AV_Output_1 output terminal 747, which is transmitted to the AV decoder 745 for further processing.

FIG. 8D is a block diagram illustrating a system configured to encrypt and store a received digital content stream in external storage, in accordance with an embodiment of the present invention. The digital content stream is received from AV encoder 740 on AV_Input_1 input terminal 742. The AV packet switch 100 is configured to route digital content streams received on AV_Input_1 input terminal 742 to DES_OUT_1 output terminal 737. The digital content stream routed to DES_OUT_1 output terminal 737 is encrypted by the DES engine 735 and transmitted to DES_IN_1 input terminal 732. The AV packet switch 100 is further configured to route digital content streams received on DES_IN_1 input terminal 732 to Time_Stamp_1 output terminal 717. The encrypted digital content stream received on input DES_IN_1 is routed to the output Time_Stamp_1, where it is time stamped by the time stamper 715 and sent to external storage 800.

FIG. 8E is a block diagram illustrating a system configured to receive an encrypted digital content stream, to decrypt the digital content stream, and to transmit the decrypted digital content stream to an AV decoder, in accordance with an embodiment of the present invention. The digital content stream retrieved from external storage 800 is sent to the timing reconstruction block 710, which reconstructs the digital content stream. The reconstructed digital content stream is sent to the AV packet switch 100 over Timing_Reconstruct_1 input terminal 712. The AV packet switch 100 is configured to route digital content streams received on Timing_Reconstruct_1 input terminal 712 to DES_OUT_1 output terminal 737. The reconstructed digital content stream received on DES_OUT_1 output terminal 737 is decrypted by the DES engine 735, and the decrypted digital content stream is forwarded to DES_IN_1 input terminal 732. The AV packet switch 100 is further configured to route digital content streams received on DES_IN_1 input terminal 732 to AV_Output_1 output terminal 747. The decrypted digital content stream received on AV_Output _1 output terminal 747 is sent to the AV decoder 745.

FIG. 8F is a block diagram illustrating a system configured to route a received digital content stream to more than one output, in accordance with an embodiment of the present invention. The AV packet switch 100 is configured to route digital content streams received on AV_Link1_Receive input terminal 702 to Time_Stamp_1 output terminal 717, to DES_OUT_1 output terminal 737, and to AV_Output_1 output terminal 747, substantially simultaneously. Thus, multiple concurrent operations can be performed on a received digital content stream. For example, the received digital content stream can be time stamped, encrypted and resent to the AV packet switch 100, and routed to an AV decoder.

FIG. 8G is a block diagram illustrating a system configured to route a digital content stream received in bit-serial format to both bit-serial and parallel outputs, in accordance with an embodiment of the present invention. The bit-serial digital content stream is received by AV_Input_1 input terminal 740. The AV packet switch 100 is configured such that AV_Input_1 input terminal 742 and AV_Output_1 output terminal 747 are configured to be in bit-serial format, and the Time Stamp_1 output terminal 717 and DES_OUT_1 output terminal 737 are in byte-parallel format. The AV packet switch 100 is also configured to route substantially simultaneously digital content streams received on AV_Input_1 input terminal 742 to Time_Stamp_1 output terminal 717, to DES_OUT_1 output terminal 737, and to AV_Output_1 output terminal 747. The bit-serial digital content stream received is routed to the AV_Output_1 output terminal 747, converted to a byte-parallel format, and routed to the Time_Stamp_1 output terminal 717 and to DES_OUT_1 output terminal 737.

The AV packet switch 100 can be used to implement a digital device that can be configured to route digital content streams between a number of devices connected to the digital device. For example, the digital device can include a combination of a digital content stream multiplexer and a hard disk drive that receives multiple digital content streams, stores selected received digital content streams in accordance with the AV-switch configuration, and transmits multiple digital content streams to external devices connected to the digital device. In one implementation, the transmitted digital content streams include the received digital content streams and digital content streams stored on the hard disk drive. The digital device can be connected to one or more external devices, e.g., set top boxes, cable television tuners, personal computers, hard disk drives, or other similar digital devices.

The systems and functional operations described in this specification can be implemented in digital electronic circuitry, and/or in computer software, firmware, and/or hardware, including the structure disclosed in this specification and equivalents thereof, and/or in combinations. They can be implemented as one or more computer program products one or more computer programs tangibly embodied in an information carrier, e.g., in a machine-readable storage device or in a propagated signal, for execution by or to control the operation of data processing apparatus, e.g., a programmable processor, a computer, or multiple computers. A computer program (also known as a program, software, software application, or code) can be written in any form of programming language, including compiled or interpreted languages, and can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network. The processes and logic flows described herein, including the method steps, can be performed by one or more programmable processors executing one or more computer programs to perform functions by operating on input data and generating output. The processes and logic flows can also be performed by, and apparatus can be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry. The foregoing has been described in terms of particular embodiments, but other embodiments can be implemented and are within the scope of the following claims. For example, the operations of the invention can be performed in a different order and still achieve desirable results.

1. An AV packet switch comprising:
a multiplexer system having multiple multiplexer input terminals and multiple multiplexer output terminals, a particular multiplexer input terminal capable to receive an input stream synchronized with a first clock signal, a particular multiplexer output terminal capable to receive the input stream from the particular multiplexer input terminal; and
an output stream destination synchronizer coupled to the particular switch output terminal capable to synchronize the input stream with a destination's clock signal.

2. The AV packet switch of claim 1,
further comprising an input stream source synchronizer having a source synchronizer data input terminal capable to receive the input stream synchronized with a source's clock signal and a source synchronizer clock input terminal capable to receive the source's clock signal, and
wherein the input stream source synchronizer is capable to synchronize the input stream received at the source synchronizer data input terminal with the first clock signal.

3. The AV packet switch of claim 1, wherein the multiplexer system is software controlled.

4. The AV packet switch of claim 1, wherein the multiplexer system includes a null source input terminal capable to receive a null source signal, and wherein the multiplexer system couples the null source input terminal to the particular multiplexer output terminal when the particular multiplexer output terminal is not configured to receive any data stream from any multiplexer input terminal.

5. The AV packet switch of claim 4, wherein the destination synchronizer includes a state machine configured to wait for an end-of-packet before changing from a particular active state.

6. The AV packet switch of claim 5, wherein the state machine is configured to go through a null state before changing from a first active state to a second active state.

7. The AV packet switch of claim 6, wherein the multiplexer system couples the null source input terminal to the particular multiplexer output terminal during the null state.

8. The AV packet switch of claim 6, wherein the multiplexer system couples the particular multiplexer input terminal to the particular multiplexer output terminal during the first active state.

9. The AV packet switch of claim 6, wherein the multiplexer system couples the particular multiplexer input terminal to a second particular multiplexer output terminal when changing to the second active state.

10. The AV packet switch of claim 9, wherein the multiplexer system maintains the particular input terminal coupled to the particular multiplexer output terminal when changing to the second active state.

11. The AV packet switch of claim 2, wherein the input stream source synchronizer obtains a backup clock signal for use when the source's clock signal is unavailable.

12. The AV packet switch of claim 1, wherein the output stream destination synchronizer obtains a backup clock signal for use when the destination's clock signal is unavailable.

13. A system comprising:
an AV packet switch having multiple switch input terminals and multiple switch output terminals, and being configurable to route data from one or more switch input terminals to one or more switch output terminals according to a configuration scheme;
a first particular switch input terminal being capable of receiving a data input stream;
a time stamper coupled to a first particular switch output terminal and being capable of time stamping individual packets of the data input stream;
a timing reconstruction block coupled to a second particular switch input terminal and being capable of receiving the individual packets time-stamped by the time stamper;
an encryption/decryption engine coupled to a second particular switch output terminal and being capable of encrypting or decrypting the data input stream;
an encryption/decryption block coupled to a third particular switch input terminal and being capable of receiving the data stream encrypted or decrypted by the encryption/decryption engine; and
a third particular switch output terminal for transmitting the data stream from the AV packet switch.

14. The system of claim 13, wherein the first particular switch input terminal is coupled to a receive engine capable of receiving the data input stream according to a format specified by IEEE 1394.

15. The system of claim 14, wherein the third particular switch output terminal is coupled to a transmit engine capable of transmitting the data input stream according to a format specified by IEEE 1394.

16. The system of claim 14, wherein the third particular switch output terminal is coupled to an AV decoder capable of transmitting the data input stream according to a format different than one specified by IEEE 1394.

17. The system of claim 13, wherein the data input stream received at the first particular switch input stream is in a serial format.

18. The system of claim 13, wherein the data input stream transmitted from the third particular switch output terminal is in a parallel format.

19. The system of claim 13, further comprising
a PID filter coupled to a fourth particular switch output terminal and being capable to extract a data program from an MPEG data stream; and
a PID filter block coupled to a fourth particular switch input terminal and being capable of receiving the extracted data program from the PID filter.

20. A method in an AV packet switch comprising:
receiving an input stream synchronized with a source's clock signal at a particular one of several switch input terminals;
synchronizing the input stream with a common clock signal;
routing the input stream to a particular one of several switch output terminals; and
synchronizing the input stream with a destination's clock signal.
